(19) United States
(12) Patent Application Publication
(10) Pub. No.: US 2006/0053100 A1
(43) Pub. Date: Mar. 9, 2006

(54) Rapid search system

(75) Inventor: Norberto Navarro Valiente, Valencia (ES)

Correspondence Address: KLAUBER & JACKSON, 411 HACKENSACK AVENUE, HACKENSACK, NJ, 07601, US

(73) Assignee: ICH SERVERS, S.L.

(21) Appl. No.: 11/136,777

(22) Filed: May 25, 2005

(30) Foreign Application Priority Data
Sep. 3, 2004 (ES) P200402128

(51) Int. Cl. G06F 17/30

(52) U.S. Cl. 707/3

(57) ABSTRACT

This facilitates searches in databanks via information transmission networks. It consists of certain means of forecasting of the data which the user is going to request depending on the searches made previously by that user. The said means of forecasting are carried out via a predetermined ordering of data according to the data most requested by the user in his or her habitual searches, and via an ordering of pre-established replies to those requests from the user.

### OBJECT OF THE INVENTION

As stated in the title of this specification, this invention refers to a rapid search process for information transmission networks, the essential aim of which consists of facilitating searches in databanks, forecasting what the user is going to request, for which it makes a predetermined ordering of data according to the data most requested by the user in his or her habitual searches and an ordering of pre-established replies to those requests from the user.

### BACKGROUND OF THE INVENTION

Searches in the Internet or similar networks are currently carried out via two defined systems:
Search engines, in which the words referencing what we wish to search for are introduced and those machines provide us with the replies they have found in their databases.
Directories ordered by categories, with different types of orderings, in which users find the web sites they are looking for depending on the subject they concern.

The first of the systems referred to has the extreme difficulty of finding the exact meaning of the words written by the user, since that meaning is subjective. The replies can vary depending on the order in which the words are written in the search phrase, or whether they are in the singular or plural, or whether the user has made a spelling mistake.

The second of these systems has the same drawback, since the categories have been edited in line with subjective concepts and users have to guess which of them contains the subject they are searching for, which causes them to become lost in the maze of the directory without finding what they are looking for.

### DESCRIPTION OF THE INVENTION

In order to achieve the objectives and avoid the drawbacks stated in the above paragraphs, the invention consists of a rapid search system which facilitates searches in databanks via information transmission networks.

According to the invention, the system, as a novelty, consists of certain means of forecasting of the data which the user is going to request as a function of the searches made previously by that user.

These means of forecasting can be carried out via a predetermined ordering of data according to the data most requested by the user in his or her habitual searches, and via an ordering of pre-established replies to those requests from the user.

According to the preferred embodiment of the invention, the aforementioned most requested data is structured into a database that includes at least one block of main words, one block of secondary words, and one block of tertiary words; while said pre-established replies are structured on a base of replies which connects with a block of means of presentation to the user.

Said block of main words can consist of data structured in such a way that it makes up solitary words, while the block of secondary words can consist of data making up groups of two words, and the block of tertiary words can consist of data making up groups of three words.

Said database can, in addition to those blocks of main, secondary and tertiary words, also include blocks of quaternary words and so on, respectively consisting of data making up groups of four words and of data making up groups of four plus n words.

The system can have means of feedback via the information sent to it by users, thereby presenting a continual updating.

With the structure that has been described, the system of the invention displays the following advantages:
The system knows beforehand what the user is going to ask it.
The system can have the words which the user searches for most often prepared in the form of menus of any kind.
The system satisfies the searches of the majority of users faster and with greater precision than systems known so far.
The main words can vary in time, depending on social interests and on the demands of users, who can propose new search words according to their needs and which are different for each language.
Users and creators of network sites can send the editors of the system those pages which they consider provide a better reply to what the users are looking for via the words.
The addition of new words and new pages to the system can be done automatically or manually.

Below, in order to facilitate a better understanding of this specification and forming an integral part thereof, a single FIGURE is attached in which, by way of illustration only and not limiting, the object of the invention has been represented.

### BRIEF DESCRIPTION OF THE FIGURE

FIG. 1.—This single FIGURE represents a functional block diagram of a rapid search system embodied according to the present invention.

### DESCRIPTION OF EMBODIMENTS OF THE INVENTION

Given below is a description of an example of the invention making reference to the numbering adopted in the FIGURE.

So, the rapid search system 1 of this example of the invention comprises a database of questions 2 which includes a block of main words 3, a block of secondary words 4 and a block of tertiary words 5.

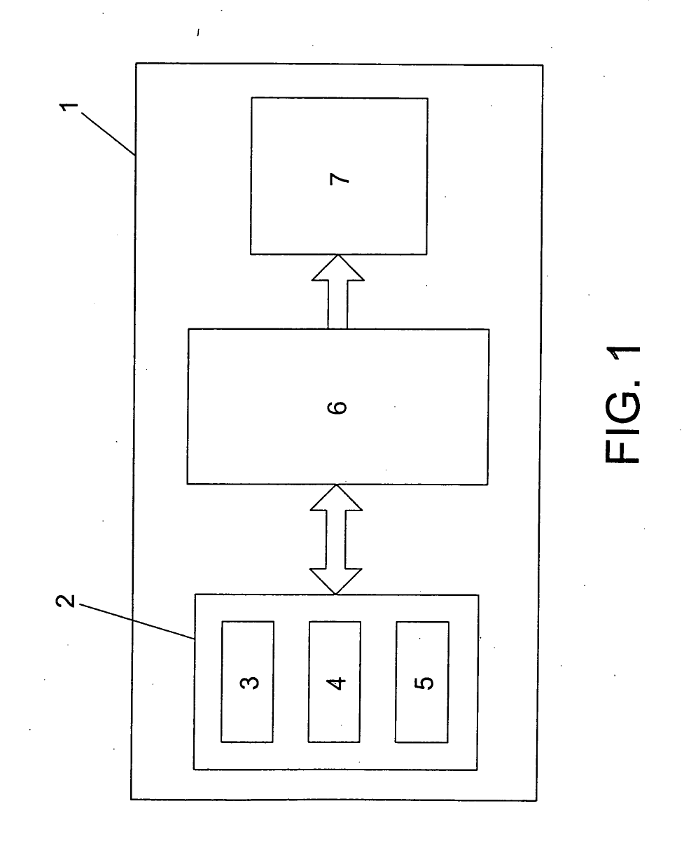

The database of questions 2 is interconnected with a database of replies 6 which is in turn connected with a block of means of presentation to the user 7, as can be appreciated in FIG. 1.

The system of this example facilitates searches in databanks via the information transmission networks and by virtue of the blocks described above certain means of forecasting of data are defined which the user is going to request depending on the searches made previously by that user.

In the rapid search system of this example, the words have been ordered by the editor of the corresponding network site so as to respond to objective search criteria.

In the present example, unlike in all known search systems, it is known beforehand what the user is going to ask and the words which the user habitually uses in his or her searches are already contained in an ordered manner, along with the pre-established replies to each of those questions.

To achieve this, a thorough investigation has been conducted into the words that are searched most in the network, and it has been determined that around 95% of the searches in a particular language are conducted on a certain number of simple words, which have been defined as “main words”, and although they vary according to the language, they do not usually exceed 500. The investigation made indicates that for each of those main words, users add between 0 and 200 accessory words, different for each of the main words, and these words have been referred to as “secondary words”. Less than just 1% of the searches made by users require a third word for specifying the search, this third word being known as the “tertiary word”. Just a minute portion of users who use this type of network require a fourth, fifth or sixth word.

The system of the present example has a functioning in which it is organised like a directory, with a search page containing the words that have been defined as main, usually ordered alphabetically. When the user clicks on the word he or she is seeking, a page is opened containing the results corresponding to that word and also the words we have called secondary that go with the chosen main word, on which the user can also click and gain access to a more detailed search, at all times finding the corresponding results along with the following accessory words (tertiary, quaternary, etc.) in order to refine the search.

In other examples of the invention, an alternative system of ordering can be provided, such as a search window, of the pop-up menu type, in any of its versions, in which the user writes the first letter of the main word he or she is looking for, and on doing so a pop-up menu appears with the main words corresponding to that letter which exist as such in the system. By selecting the one that is desired, the page of results which also contains the accessory words is then accessed.

A third alternative method of organisation of the system would be one in which the search page contains just the letters of the alphabet and, when any of them is clicked on with the mouse, or the mouse is simply passed over any of them, a pop-up menu will be opened of the main words corresponding to that letter. By selecting the one that is wished, access is then gained to the results page where the accessory words are also to be found.

A fourth alternative method of presentation by the system would be by means of a voice recognition system by the computing system. The user tells the system the main word that he or she wants to search for and it will give him or her the replies, either on the screen or by means of sounds emitted by the system's loudspeakers; and the system would show him or her the secondary words which the user can choose, either on the screen or by means of sound transmission.

The presentation of the results can be done according to the criterion of the editor, without this substantially modifying the system. The presentation of the system can be any of those mentioned, and alternative presentations can exist which do not modify its novelty.

Moreover, the system can be fed back with information sent to it by users and be continually updated.

1. RAPID SEARCH SYSTEM, which facilitates searches in databanks via information transmission networks; wherein it comprises means of forecasting of the data that the user is going to request depending on the searches made previously by said user.

2. RAPID SEARCH SYSTEM, according to claim 1, wherein said means of forecasting are carried out by means of a predetermined ordering of data according to the data most requested by the user in the habitual searches of the user, and by means of an ordering of pre-established replies to those requests from the user.

3. RAPID SEARCH SYSTEM, according to claim 2, wherein said most requested data are structured into a database that includes at least one block of main words, one block of secondary words and one block of tertiary words; while said pre-established replies are structured on a base of replies which connects with a block of means of presentation to the user.

4. RAPID SEARCH SYSTEM, according to claim 3, wherein said block of main words comprises data structured in such a way that it makes up solitary words, while the block of secondary words comprising data making up groups of two words, and the block of tertiary words consists of data making up groups of three words.

5. RAPID SEARCH SYSTEM, according to claim 3, wherein said database includes, in addition to said blocks of main, secondary and tertiary words, blocks of quaternary words and so on, respectively comprising data making up groups of four words and of data making up groups of four plus n words, said words being different for each language.

6. RAPID SEARCH SYSTEM, according to claim 1, wherein the system has means of feedback via the information sent to the system by the users, thereby presenting a continual updating.
